(19) United States
(12) Patent Application Publication
(10) Pub. No.: US 2010/0213139 A1
(43) Pub. Date: Aug. 26, 2010

(54) SEGMENTED FILTER SYSTEM FOR A DEEP FRYER

(75) Inventors: HENRY PRESTON HUTSON, Bossier City, LA (US); John M. KINCH, Keithville, LA (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: FRYMASTER, LLC.

(21) Appl. No.: 12/709,092

(22) Filed: Feb. 19, 2010

Related U.S. Application Data
(60) Provisional application No. 61/208,133, filed on Feb. 20, 2009.

(51) Int. Cl. A47J 37/12; B01D 35/28

(52) U.S. Cl. 210/767; 99/408; 210/435

(57) ABSTRACT

The present disclosure provides a segmented filter system for a deep fryer. The filter system includes a first filtering segment for removing large debris out of the flow of oil through the fryer. The filtered oil then flows through a second filtering segment, whereby most smaller debris is removed from the oil and the cleaned oil continues flowing through the fryer. Thus, the large debris is removed, so as not to contaminate the subsequent flow of oil.

### CROSS-REFERENCE TO RELATED APPLICATION

This application claims the benefit of U.S. Provisional Application No. 61/208,133 filed on Feb. 20, 2009, which is incorporated by reference herein.

### BACKGROUND OF THE INVENTION

1. Field of the Invention

The present invention relates to a filter system for a deep fryer. More particularly, the present invention relates to a segmented filter system for extending the useful life of cooking oil used in a deep fryer.

2. Description of the Related Art

Gas fired deep fryers used in the commercial cooking industry must be able to quickly heat oil for cooking large amounts of food that will meet customers' expectations. The deep fryer must accommodate a sufficient depth and volume of oil to evenly cook the desired quantity of food. Further, the cooking oil must be as free of cooked particles and debris as possible during the cooking process to maintain and even extend the oil's useful life. Additionally, food vendors must balance customer expectations against the high cost of cooking oil and fryer maintenance, so clean oil provides several advantages.

Further, an optimal fryer design provides for quick and easy removal of such debris from the cooking oil, and either cleaning or discarding of the filters used to clean the oil. The debris will be of various sizes, which requires a filtering apparatus capable of separating different size debris as soon as possible in the cooking cycle. Although various designs of filtering devices have been used in an effort to improve overall cooking efficiency and useful life of the oil, drawbacks still exist. Many such designs require large and unwieldy filtering systems that do not allow for easy and quick operation or maintenance by non-technical staff.

Accordingly, there exists a need for a segmented filter system that separates large debris from the cooking oil as soon as possible so that the subsequent flow of oil does not interact with this large debris.

### SUMMARY OF THE INVENTION

The present disclosure provides a segmented filter system having filtrating and eliminating components that filter and segregate debris of various sizes out of the oil as soon as possible in the cooking cycle.

The present disclosure also provides for a deep fryer having a segmented filter system that includes a first filtering segment for removing large size debris and a second filtering segment for removing smaller debris, so that the large size debris does not clog and render the second segment unusable, or remain in the oil any longer than necessary.

The present disclosure further provides for a deep fryer having a segmented filter system that avoids the passing of the flow of oil over debris that has been previously removed, so that the subsequently filtered oil does not pick up unnecessary debris particles.

The present disclosure yet further provides for a segmented filter system for a deep fryer, where one segment eliminates large debris from contact with the subsequent flow of oil and another segment remains unaffected by such large debris and can eliminate smaller size debris effectively.

The present disclosure still further provides for a segmented filter system for a deep fryer, which has a first filtering segment for removing large debris and a second filtering segment for removing smaller debris from the oil, where the first segment has a first portion through which the oil flows and a second portion for collection of debris filtered out of the oil, where the second segment receives the flow of oil from the first portion and, preferably, but not required, includes a source of suction for more effectively separating the smaller debris from the oil.

The present disclosure yet further provides a segmented filter system for a deep fryer which includes a screened, inclined portion, a debris collection portion, a filter media, and, preferably, a source of suction, where the oil flows first through the screened, inclined portion and then onto the filter media, the larger debris in the oil is transferred from the screened, inclined portion to a collection portion by falling into such collection portion, the smaller, unfiltered debris in the oil is collected on the filter media, and suction pulls the remaining oil through the filter media leaving the smaller debris behind.

Other and further benefits, advantages and features of the present disclosure will be understood by reference to the following specification in conjunction with the accompanying drawings, in which like reference characters denote like elements of structure.

### BRIEF DESCRIPTION OF THE DRAWINGS

FIG. 1 illustrates a perspective view of a deep fryer, including a removable, segmented filter system, according to the present invention;

FIG. 2 illustrates the oil flow manifold and drain shown in FIG. 1, in dotted line, in place over the segmented filter system, according to the present invention; and

FIG. 3 illustrates the segmented filter system of FIG. 2 removed from the deep fryer, including an exploded view of the first filtering segment of the system separated from the second filtering segment of the system, according to the present invention.

### DETAILED DESCRIPTION OF THE PREFERRED EMBODIMENTS

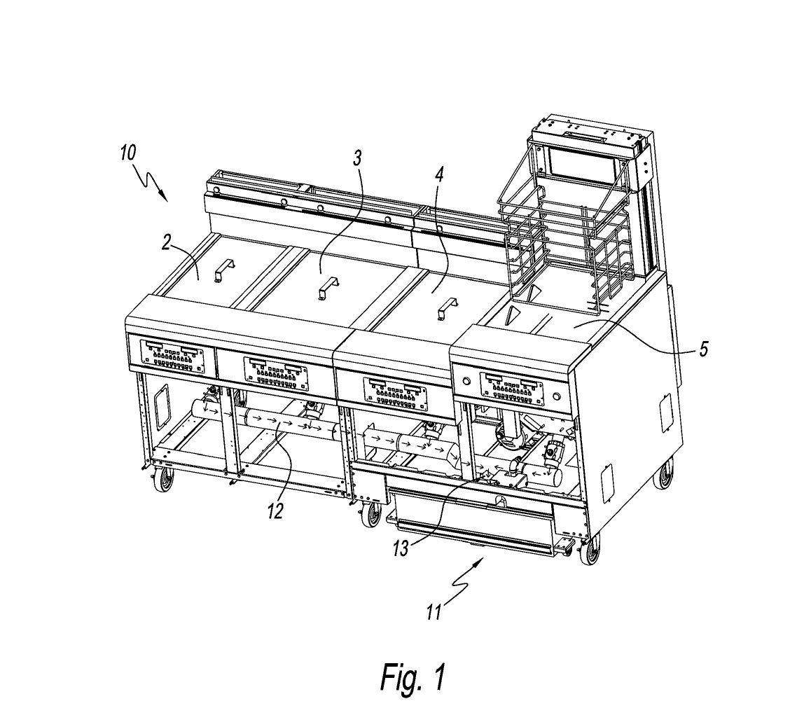

Referring to FIG. 1, a gas fired deep fryer is shown, and generally referred to by reference numeral 10. Fryer 10 has a plurality of fryer pots 2, 3. 4, and 5. Used cooking oil in pots 2 through 5 drains into a manifold 12. Oil that drains from pots 2 through 5 is filtered in a segmented filter system, generally referred to by reference numeral 11. An oil drain 13 in communication with manifold 12 extends downwardly from manifold 12 above segmented filter system 11. During operation of fryer 10, oil flowing through manifold 12 passes through drain 13 into segmented filter system 11 for removal of debris from the oil.

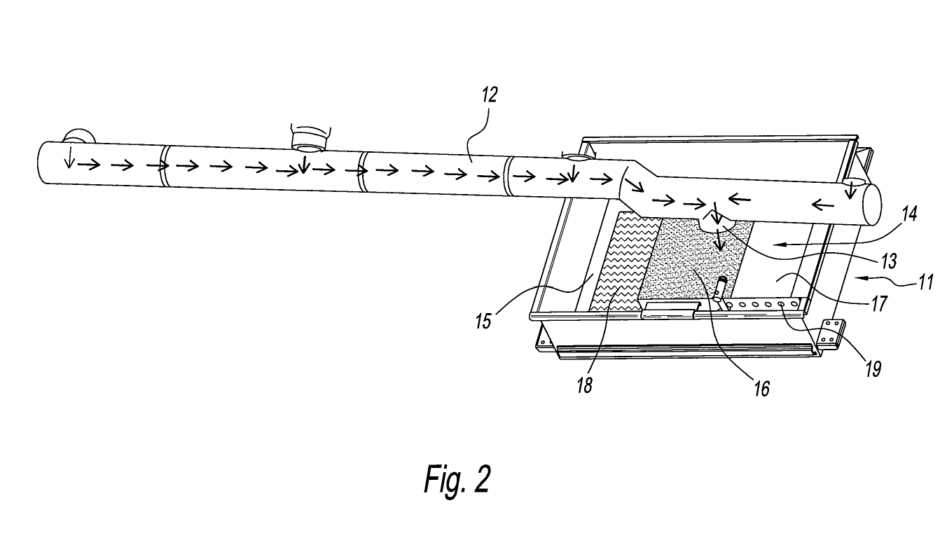

Referring to FIG. 2, segmented filter system 11 includes a first filtering segment 14 and a second filtering segment 15. The oil flows from drain 13 into first segment 14, where large debris is removed from the oil flow, and then onto second filtering segment 15, where the smaller debris is separated from the oil.

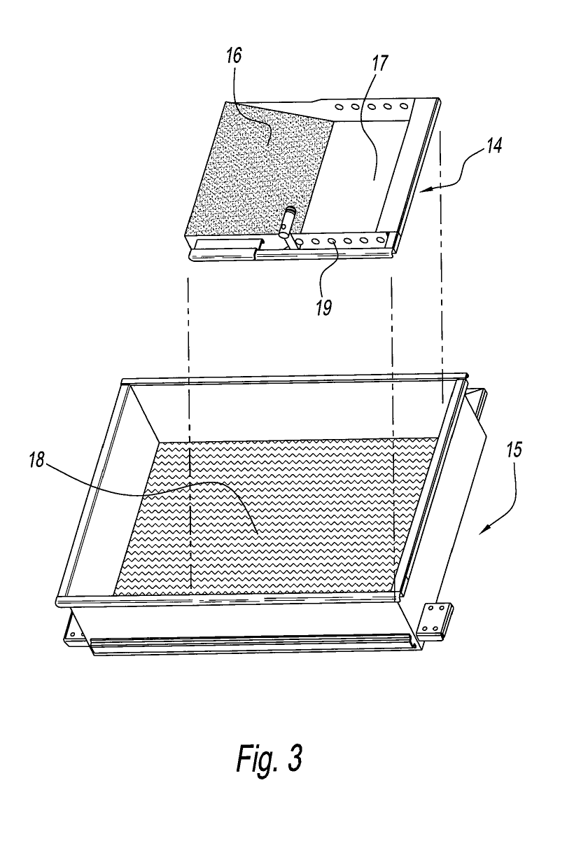

As more easily seen in FIG. 3, first segment 14 includes a screened, inclined portion 16 and a flat debris collection portion 17 contiguous with portion 16. On the floor of second segment 15 is filter media 18, which lies below first segment 14.

Oil that has been used for cooking is drained through manifold 12 in fryer 10 and drops through drain 13 onto screened, inclined portion 16. The size of the perforations in screened portion 16 will be dependent on the size of debris that one wishes to retain with this screen. Debris that is able to pass through screened portion 16 drops onto filter media 18 along with the oil being filtered. The larger debris that cannot pass through the perforations in screened portion 16 is transferred from portion 16 to collection portion 17 by rolling down the incline and being collected on portion 17 for removal. Holes 19 are provided in collection portion 17 in case any oil that accumulates there will also drop onto filter media 18.

The oil flowing onto filter media 18 from screened, inclined portion 16 will again be filtered to separate the remaining, unfiltered smaller size debris that was not captured by portion 16 from the oil. Preferably, suction is applied against the bottom of filter media 18 to enhance and accelerate this separation. “Unfiltered debris” means debris that was not captured on portion 14.

Thus, segmented filter system 11 insures that the subsequent flow of oil onto screened, inclined portion 16 does not come into contact with the larger debris previously collected in collection portion 17. In that way, the oil flowing onto filter media 18 is cleaner, and filter media 18 does not have to be replaced as often. For example, instead of being replaced three times per day, filter media 18 will only have to be replaced once. Also, the large debris on collection portion 17 can be easily and quickly removed several times per day.

Modifications to this disclosure will be apparent to one skilled in the art, based on the teachings herein. For instance, screened, inclined portion 16 could be adjustably attached to collection portion 17, but still allow for the larger debris to be collected in portion 17 and not allow unfiltered oil to drop onto filter media 18. In this case, the incline angle of screened, inclined portion 16 could be set for maximum filtering efficiency based on the speed of the oil flow, size of particles to be removed and other parameters chosen by the user. Instead of using removable, filter media, either on screened, inclined portion 14 or in second filtering segment 15, one could use built-in metal filters that would have to be cleaned, instead of being removed and discarded. Also, more than one screened, inclined portion 16 could be employed to allow for increased screening of the oil before it contacts filter media 18, thus balancing the effort necessary to clean such additional portion against the cost of replacing filter media 18.

Further, vibration may be applied to enhance movement of the larger debris into collection portion 17 and/or to enhance filtration of the smaller, unfiltered debris through filter media 18. Also, instead of drain 13 being placed in a fixed position, drain 13 could be adjustably positioned to direct oil flow to any desired point on segment 14, or even on segment 15.

Having described the disclosure in detail by reference to the preferred embodiments, other modifications to this disclosure will be apparent to one skilled in the art, without departing from the scope of this invention.

What is claimed is:

1. A filter for an oil fryer comprising:
a first portion for separating debris from oil flowing though the fryer, and a second portion for collecting such debris,
wherein the debris is transferred from the first portion to the second portion.

2. The filter of claim 1, wherein the first portion is inclined with respect to the second portion, whereby the debris falls onto the second portion out of the subsequent flow of oil through the first portion.

3. A segmented filtration system for an oil fryer comprising:
a first segment for filtering debris from oil flowing through the fryer, the first segment having a first portion though which the oil flows for filtering the debris from the oil and a second portion for collecting the filtered debris,
wherein the filtered debris is transferred from the first portion to the second portion; and
a second segment for separating most remaining, unfiltered debris from the oil flowing from the first segment through the second segment.

4. The system of claim 3, wherein the first portion is inclined with respect to the second portion, whereby the filtered debris falls onto the second portion out of the subsequent flow of oil through the first portion.

5. The system of claim 3 further comprising a filter media in the second segment through which the oil flows from the first segment.

6. The system of claim 5 wherein the filter media is removable for disposal.

7. The system of claim 3 wherein the first and second segments are removable from the fryer for the cleaning or disposal.

8. A method for removing debris from oil flowing through an segmented filter system comprising:
directing an oil flow though a first portion of the system;
separating the debris from the oil in the first portion; and,
transferring the debris from the first portion to a second portion of the system.

9. The method of claim 8, wherein the first portion is inclined with respect to the second portion, and the debris falls onto the second portion out of the subsequent flow of oil through the first portion.

10. The method of claim 8, further comprising a third portion of the system, wherein said third portion receives the oil flow from said first portion and filters unfiltered debris from the oil flow.
